(19) United States
(12) Patent Application Publication
(10) Pub. No.: US 2008/0101317 A1
(43) Pub. Date: May 1, 2008

(54) System and method for providing advanced session control of a unicast session

(75) Inventor: Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/589,626

(22) Filed: Oct. 30, 2006

(51) Int. Cl. H04B 7/216

(52) U.S. Cl. 370/342

(57) ABSTRACT

A system and method for providing improved session control in unicast sessions such as FLUTE sessions. According to various embodiments, a series of new commands are defined that permit a receiver to perform actions such as request a list of files to be delivered, trigger the delivery of selected files, ask that certain files not be delivered, and others. As a result, the bandwidth usage between the sender and the receiver can be reduced, and the data flow between the devices can be optimized.

### FIELD OF THE INVENTION

The present invention relates generally to establishment and implementation of unicast sessions. More particularly, the present invention relates to the control of unicast sessions, such as sessions conducted in accordance with push-type data delivery protocols such as the File Delivery Over Unidirectional Transport (FLUTE) protocol.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, mobile broadcast solutions have been standardized by different organizations, such as the 3^{rd} Generation Partnership Project (3GPP) Multimedia Broadcast Multicast Service (MBMS), the Digital Video Broadcasting (DVB) Convergence of Broadcast and Mobile Services (CBMS), and the Open Mobile Alliance (OMA) Broadcast (BCAST) organizations. The two primary services provided by such multicast/broadcast solutions are streaming and file delivery services. Although streaming services are considered to be the primary driver of this technology, file delivery is expected to generate a significant amount of the traffic and activity over time. For example, in the delivery of music and video clips, the file delivery may comprise the primary application component. Alternatively, file delivery may be a secondary component of the application, such as in the case of rich media applications and zapping streams.

In the case of file delivery, FLUTE can be used as the file delivery protocol. As discussed in the Network Working Group's Request for Comments (RFC) 3926, which can be found at www.ietf.org/rfc/rfc3926.txt and is incorporated herein by reference in its entirety, FLUTE is defined by the Internet Engineering Task Force (IETF), and a revision of this document is currently in progress. FLUTE is based on Asynchonous Layered Coding (ALC) Protocol Instantiation, which can be found in RFC 3450 (www.ietf.org/rfc/rfc3451.txt, www.ietf.org/rfc/rfc3451.txt, incorporated herein by reference in its entirety.) ALC comprises a set of building blocks such as the Layered Coding Transport (LCT) block, which can be found in RFC 3451 (www.ietf.org/rfc/rfc3451.txt, www.ietf.org/rfc/rfc3451.txt, incorporated herein by reference in its entirety) and the Forward Error Correction (FEC) building block, which can be found in RFC 3452 (www.ietf.org/rfc/rfc3452.txt, incorporated herein by reference in its entirety). FLUTE extends ALC by, among others, defining mechanisms to describe the contents of the FLUTE session. This is achieved by introducing a well-known object with a Transport Object Identifier (TOI) equal to 0, carrying a File Delivery Table (FDT) instance. The FDT instance lists a set of files and their corresponding transport options. The FDT is an XML file following a schema defined in the FLUTE specification.

3GPP is currently specifying extensions to the Multimedia Broadcast/Multicast Service (MBMS) file download and streaming methods. One of the goals of these extensions is to enable service delivery over a unicast session. This is especially important in the case where users happen to leave a multicast coverage area and only have the unicast channel available for data reception. The enabling of service delivery over a unicast session is accomplished by providing for appropriate signaling so as to indicate to the receiver the existence of an alternative unicast session that delivers the same content as the multicast/broadcast session.

When delivering files of a file download session over a broadcast channel to a user, the content of the session usually cannot be personalized according to user preferences. This is due to the broadcast nature of the delivery. As a result of this system, receivers have to select the content that the user is interested in and discard the rest of the content. In unicast delivery, on the other hand, the receiver and the sender establish a point-to-point connection for their communication. This allows for more freedom in customizing the session content.

When moving out of multicast/broadcast coverage, a user may wish to continue receiving the files of a file download session. In such a case, the receiver first connects to a FLUTE unicast server that was signaled in a session announcement or elsewhere. The FLUTE unicast server forwards the content of the multicast/broadcast session to the unicast receiver. However, this arrangement possesses a number of disadvantages. For example, in this arrangement, the receiver receive all of the files of the broadcast/multicast session over the unicast bearer, which is likely to be relatively expensive, even though the user might not be interested in all of the session files. Additionally, in this arrangement, the receiver must wait for the content of interest to be available over the multicast/broadcast channel before it can be received over the unicast channel. Furthermore, the FLUTE unicast server is presumed to be a receiver of the multicast/broadcast FLUTE session and to act as a forwarding unit, but this may not always be a case. All of these limitations impact the overall performance and cost efficiency of the sender and receiver(s). Although the File Transfer Protocol (FTP), which can be found at www.ietf.org/rfc/rfc959.txt and incorporated herein by reference in its entirety, allows for some control of a file delivery session, the listing of a remote file system and the reception of selected files, it would be desirable to provide a system that enables for more flexible control of a unicast FLUTE channel.

### SUMMARY OF THE INVENTION

Various embodiments of the present invention provide a system and method for controlling a FLUTE unicast session. According to various embodiments, a variety of commands can be used to trigger certain actions in a unicast session. These commands can result in actions such as the delivery of a current file list, the delivery of a single file or group of files, and other functions. With these commands, the control of a FLUTE session delivered in unicast mode can be extended. Both the sender and receiver of files benefit from such advanced control by reducing their bandwidth usage and optimizing the data flow between the FLUTE server (or other FLUTE sender) and the receiver. Various embodiments of the present invention can be implemented with virtually any push-type data delivery protocol, including the FLUTE protocol and other ALC-based protocols.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing a receiver's interaction with a FLUTE server or other sender via a unicast network when the receiver is not within a particular broadcast/multicast coverage area;

FIG. 2 is a chart showing the implementation of one embodiment of the present invention using a real-time streaming protocol (RTSP);

FIG. 3 is a perspective view of a mobile device that can be used in the implementation of the present invention; and

FIG. 4 is a schematic representation of the circuitry of the mobile telephone of FIG. 3.

### DETAILED DESCRIPTION OF VARIOUS EMBODIMENTS

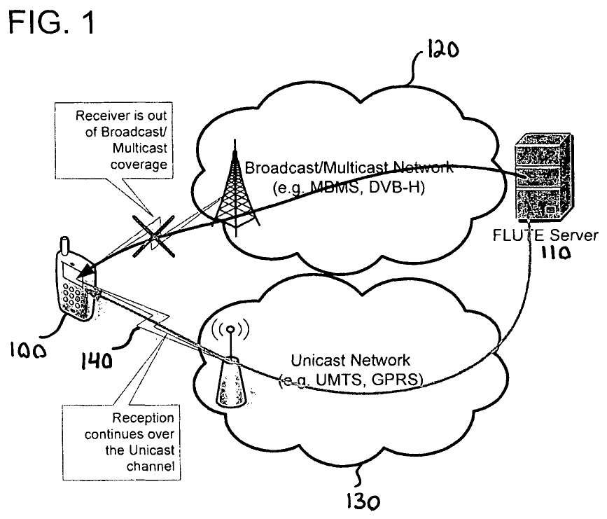

Various embodiments of the present invention provide a system and method for controlling a unicast session in accordance with a push-type data delivery protocol, such as the FLUTE protocol or other ALC-based protocols. FIG. 1 is a representation showing the interaction between a receiver 100 and a FLUTE server or sender 110 according to the various embodiments discussed herein. It should be noted that, although the following description contained herein refers specifically to the use of the FLUTE protocol, the various embodiments of the present invention can be implemented in virtually any push-type data delivery protocol, where files are “pushed” from the server to the receiver.

As depicted in FIG. 1, the FLUTE sender 110, which may also comprise other types of senders, and the receiver 100 are both capable of communicating over both a broadcast/multicast network 120 (such as a MBMS or DVB-H network) and a unicast network 130, such as a Universal Mobile Telecommunications System (UMTS) or general packet radio service (GPRS) network. At a certain point in time, the receiver 100 may move out of broadcast/multicast coverage, requiring that communication switch to a unicast channel, which is represented at 140 in FIG. 1.

According to various embodiments, a variety of commands can be used to trigger certain actions in a unicast session. These commands can result in actions such as the delivery of a current file list, the delivery of a single file or group of files, and other functions. With these commands, the control of a FLUTE session delivered in unicast mode can be extended. Both the sender and receiver of files benefit from such advanced control by reducing their bandwidth usage and optimizing the data flow between the FLUTE sender 110 and the receiver 110.

The following commands may be used for the control of a FLUTE session in one particular embodiment. It should also be noted, however, that other commands may also be used in accordance with the principles of the present invention.

The LIST command triggers the delivery of a current file list from the FLUTE sender 110 to the receiver 100. The response to the LIST command may comprise, for example, the actual FDT instance or a list of file uniform resource identifiers (URIs). The FDT may either be sent as a reply to the request or in the FLUTE session itself.

The GET command triggers the delivery of a single file or set of files from the FLUTE sender 110 to the receiver 100. In the body of the command, a list of the requested files is given. The FLUTE sender 110 may deliver the requested files immediately or at a later time when they become available.

The MASK command is a command that is sent by the receiver 100 to the FLUTE sender 110. The MASK command informs the FLUTE sender 110 that the receiver 100 does not want to receive a specific file or files. The body of the command carries the list of files that are not to be transmitted to the receiver 100.

The PAUSE command is a command that is also sent by the receiver 100 to the FLUTE sender 110. The PAUSE command serves to request a temporary stoppage of data transmission, without a concomitant teardown of the session. The PLAY command, which is also sent by the receiver 100, indicates that data transmission from the FLUTE sender 110 to the receiver 100 should be resumed.

In addition to the above, it is also possible to indicate a range of transport objects, source blocks, and encoding symbols within individual requests for data transmission (such as PLAY or GET requests/commands).

One implementation of embodiments of the present invention is based on RTSP. An Internet draft of RTSP 2.0 can be found at www.ietf.org/internet-drafts/draft-ietf-mmusic-rfc2326bis-13.txt and is incorporated herein by reference in its entirety.

In RTSP 2.0, a request message uses the following format, regardless of whether the request originated with a server or client. The request begins with a request line, which contains the method to be applied to the resource, the identifier of the resource, and the protocol version in use. This is followed by zero or more header lines. These header lines can be “general,” “request” or “entity” types. An empty line is used to indicate the end of the header section. A message body (entity) may also be included. If included, the message body contains one or more lines. The length of the message body (in number of bytes) is indicated by a Content-Length entity header.

The Content-Length general header field contains the length of the body (entity) of the message. Session request-header and response-header fields identify an RTSP session. An RTSP session is created by the server as a result of a successful SETUP request and, in the response, the session identifier is given to the client. The RTSP session exists until destroyed by a TEARDOWN request or a time out by the server. A CSeq general-header field specifies the sequence number for a RTSP request-response pair.

A variety of “method” requests/commands are used to indicate the task that is to be performed on the resource identified by the Request uniform resource identifier (URI). One such method is a RTSP OPTIONS method. This method is bi-directional, in that a client can request it to a server and vice versa. A client must implement the capability to send an OPTIONS request, and a server or a proxy must implement the capability to respond to an OPTIONS request. The client, server or proxy may also implement the converse of their required capability. An OPTIONS request may be issued at any time. Such a request does not modify the session state. However, the request may prolong the session lifespan. The URI in an OPTIONS request determines the scope of the request and the corresponding response. If the Request URI refers to a specific media resource on a given host, then the scope is limited to the set of methods supported for that media resource by the indicated RTSP agent. A Request URI with only the host address limits the scope to the specified RTSP agent's general capabilities without regard to any specific media. If the Request-URI is an asterisk (“*”), the scope is limited to the general capabilities of the next hop (i.e., the RTSP agent in direct communication with the request sender). Regardless of scope of the request, the Public header must always be included in the OPTIONS response, listing the methods that are supported by the responding RTSP agent. In addition, if the scope of the request is limited to a media resource, then the Allow header must be included in the response to enumerate the set of methods that are allowed for that resource unless the set of methods completely matches the set in the Public header. If the given resource is not available, the RTSP agent should return an appropriate response code, such as 3rr or 4xx. The supported header may be included in the request to query the set of features that are supported by the responding RTSP agent.

A GET_PARAMETER request retrieves the value of a parameter or parameters for a presentation or stream specified in the URI. If the Session header is present in a request, then the value of a parameter must be retrieved in the specified session context. The content of the reply and response is left to the implementation.

It should also be noted that the method may also be used without a body (entity). If the request is successful, i.e., a 200 OK response is received, then the keep-alive timer has been updated. Any non-required header present in such a request may or may not been processed. To allow a client to determine if any such header has been processed, it is necessary to use a feature tag and the Require header. Due to this reason, it is recommended that any parameters to be retrieved are sent in the body, rather than using any header.

There has been a proposal in the 3GPP and IETF for controlling FLUTE sessions using RTSP as described in an Internet draft which can be found at www.ietf.org/internet-drafts/draft-lohmar-mmusic-rtsp-flute-00.txt and is incorporated herein by reference in its entirety. This document has proposed extending RTSP functionality to support FLUTE session control. However, the only control granularity that was defined in this document is the starting and stopping of data transmission. The defined mechanism may be extended to support fine granularity control as described in the various embodiments of the present invention.

With various embodiments of the present invention, a number of functionalities may be realized. One such functionality involves the exchanging of capabilities information between devices. For example, the receiver 100 may query the FLUTE sender 110 to find out whether the advanced FLUTE session control commands are supported. This can be realized using the OPTIONS command. Alternatively, a feature tag, for example “3gpp.org.advanced-flute-control”, is defined and may be used by the receiver and sender in the “Supported” header field to indicate their support of these features. If the advanced FLUTE session control is not supported, then the receiver 100 should not send the requests to the FLUTE sender 110.

Additionally, new commands are clearly possible when implementing various embodiments of the present invention. In particular, new RTSP methods are defined to cover the LIST, GET and MASK commands discussed above. Alternatively, the commands may be sent in the body of “SET_PARAMETER” and “GET_PARAMETER” requests. In the latter case, new parameters are defined for the commands. For example, in this case a “LIST” parameter sent in the body of a GET_PARAMETERS request triggers the transmission of the FDT or a list of the files of the FLUTE session, either in the response to the GET_PARAMETERS request or in the FLUTE session itself (in case the reply is an FDT instance).

In one embodiment, the RTSP PLAY request is modified to include a new range header field. The range header field, which has conventionally been used to carry time range, is modified to carry TOIs, source blocks, and encoding symbol ranges, in order to indicate to the FLUTE sender 110 the detailed data portions that have been requested by the receiver 100.

The following is an example of a modified PLAY request according to one embodiment, for example:

| | |
|---|---|
| Receiver -> Sender: | PLAY rtsp://example.com/flute/session1 |
| RTSP/2.0 | |
| | CSeq: 84 |
| | Session: 5428765 |
| | Range: TOI=45;SBN=2;ESI=2–34, TOI=34 |

An example use of a GET_PARAMETER request according to one embodiment is as follows, for example:

```
Receiver -> Sender: GET_PARAMETER
rtsp://example.com/flute/session1 RTSP/2.0
              CSeq: 17
              Session: 5428765
              Content-Length : 6
          LIST
Sender->Receiver : RTSP/2.0 200 OK
              CSeq: 17
              Content-Length: 325
              Content-Type: text/flute.fdt-instance
      <FDT-Instance>
    <File>...
```

The GET and MASK commands can be implemented in several different ways in RTSP. For example, these commands can be included in header fields of a PLAY method, such as in the following, for example:

```
  Receiver -> Sender: PLAY rtsp://example.com/flute/session1
RTSP/2.0
            CSeq: 84
            Session: 5428765
            GET: TOI=23
            MASK: TOI=24
```

The GET and MASK commands can also be included as parameters in a SET_PARAMETER request, such as in the following:

```
Receiver -> Sender: SET_PARAMETER
rtsp://example.com/flute/session1 RTSP/2.0
            CSeq: 17
            Session: 5428765
            Content-Length: 6
            Content-type: text/parameters
        GET: TOI=13,TOI=54
            MASK: TOI=14
```

GET and MASK commands can also be used as range indications in the PLAY method as specified above.

With regard to capability exchange, this functionality can be achieved using an OPTIONS request and by defining a new feature tag as follows:

```
Receiver->Sender: OPTIONS * RTSP/2.0
            CSeq: 1
                User-Agent: NokiaClient/1.0
                Supported: play.basic, 3gpp.org.advanced-flute-
    control
Sender->Receiver: RTSP/2.0 200 OK
            CSeq: 1
            Public: DESCRIBE, SETUP, TEARDOWN,
    PLAY, PAUSE
            Supported: play.basic, implicit-play,
    3gpp.org.advanced-flute-control
            Server: NokiaServer/1.1
```

This particular method of implementation has no other implications on other methods and on the used header fields. In other words, traditional RTSP header fields may be used in the same manner as done previously, with the RTSP methods as defined in the Internet Draft of RTSP 2.0, which is found at www.ietf.org/internet-drafts/draft-ietf-mmusic-rfc2326bis-13.txt.

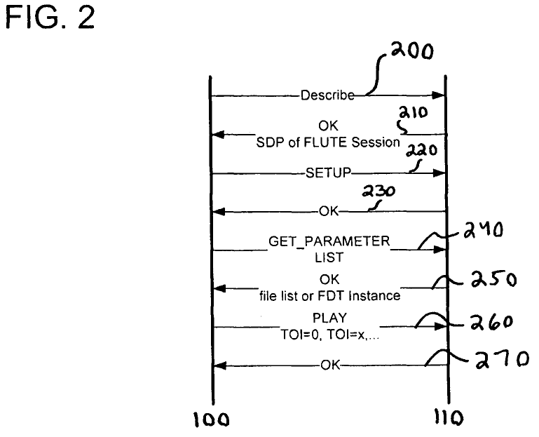

FIG. 2 shows an example implementation of one embodiment of the present invention using RTSP. At 200 in FIG. 2, the receiver 100 sends a “Describe” message to the FLUTE sender 110. the FLUTE sender 110 responds with an “OK” message at 210, as well as a session description protocol (SDP) description of the FLUTE session. At 220, the receiver sends a “SETUP” request to the FLUTE sender 110, which acknowledges this request at 230. At 240, the receiver 100 sends a “GET_PARAMETER LIST” request to the FLUTE sender 110. In response, at 250 the FLUTE sender 110 acknowledges the request and sends to the receiver 100 a list of files to be sent or the FDT instance. At 260, the receiver 100 sends a PLAY command to the FLUTE sender 110, requesting that transmission proceed. In this particular example, the PLAY command also includes a range of TOIs that should be transmitted by the FLUTE sender 110. This command is acknowledged by the FLUTE sender 110 at 270 and is followed by transmission of the designated TOIs.

Both sending and receiving devices may communicate using various transmission technologies including, but not limited to, Code Division Multiple Access (CDMA), Global System for Mobile Communications (GSM), UMTS, Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

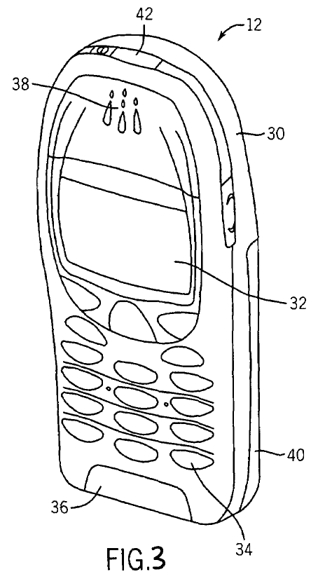

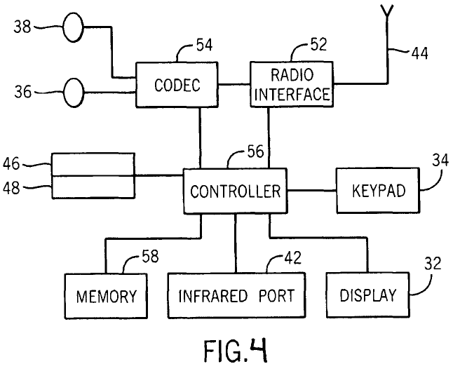

FIGS. 3 and 4 show one representative mobile telephone 12 within which the present invention may be implemented. It should be understood, however, that the present invention is not intended to be limited to one particular type of mobile telephone 12 or other electronic device. The mobile telephone 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
transmitting a command to a sending device, the command indicating how the sending device should transmit content using a unicast session in accordance with a push-type data delivery protocol; and
receiving information from the sending device, the information relating to the unicast session and being in accordance with the indication provided by the transmitted command.

2. The method of claim 1, wherein, in response to the command, the received information comprises a current file list from the sending device.

3. The method of claim 2, wherein, in response to the command, the received information comprises a list of file Uniform Resource Identifiers (URIs).

4. The method of claim 2, wherein, in response to the command, the received information comprises a file delivery table (FDT) instance.

5. The method of claim 4, wherein the FDT instance is received within the unicast session.

6. The method of claim 1, wherein the information comprises at least one specific file received from the sending device.

7. The method of claim 1, wherein the command informs the sending device that at least one specific file should not be transmitted.

8. The method of claim 1, wherein the command informs the sending device to temporarily stop data transmission without tearing down the unicast session.

9. The method of claim 1, wherein the command informs the sending device that data transmission should be resumed.

10. The method of claim 1, wherein the command further indicates at least one of a range of transport objects, source blocks and encoding symbols.

11. The method of claim 1, wherein the method is implemented in accordance with a real-time streaming protocol (RTSP).

12. The method of claim 1, further comprising, before transmitting the command:
querying the sending device regarding whether the command is supported; and
receiving an answer to the query, the answer indicating whether the command is supported.

13. The method of claim 1, wherein the command is transmitted within a SET_PARAMETER message that is transmitted to the sending device.

14. The method of claim 1, wherein the command is transmitted within a GET_PARAMETERS message that is transmitted to the sending device.

15. The method of claim 1, wherein the push-type data delivery protocol is a File Delivery Over Unidirectional Transport (FLUTE) protocol.

16. A computer program product, embodied in a computer readable medium, comprising:
computer code for transmitting a command to a sending device, the command indicating how the sending device should transmit content using a unicast session in accordance with a push-type data delivery protocol; and
computer code for receiving information from the sending device, the information relating to the unicast session and being in accordance with the indication provided by the transmitted command.

17. An apparatus, comprising
a processor; and
a memory unit communicatively connected to the processor and including:
computer code for transmitting a command to a sending device, the command indicating how the sending device should transmit content using a unicast session in accordance with a push-type data delivery protocol; and
computer code for receiving information from the sending device, the information relating to the unicast session and being in accordance with the indication provided by the transmitted command.

18. The apparatus of claim 17, wherein, in response to the command, the received information comprises a current file list from the sending device.

19. The apparatus of claim 18, wherein, in response to the command, the received information comprises a list of file Uniform Resource Identifiers (URIs).

20. The apparatus of claim 18, wherein, in response to the command, the received information comprises a file delivery table (FDT) instance.

21. The apparatus of claim 20, wherein the FDT instance is received within the unicast session.

22. The apparatus of claim 17, wherein the information comprises at least one specific file received from the sending device.

23. The apparatus of claim 17, wherein the command informs the sending device that at least one specific file should not be transmitted.

24. The apparatus of claim 17, wherein the command informs the sending device to temporarily stop data transmission without tearing down the unicast session.

25. The apparatus of claim 17, wherein the command informs the sending device that data transmission should be resumed.

26. The apparatus of claim 17, wherein the command further indicates at least one of a range of transport objects, source blocks and encoding symbols.

27. The apparatus of claim 17, wherein the method is implemented in accordance with a real-time streaming protocol (RTSP).

28. The apparatus of claim 17, wherein the memory unit further comprises computer code for, before transmitting the command:
querying the sending device regarding whether the command is supported; and
receiving an answer to the query, the answer indicating whether the command is supported.

29. The apparatus of claim 17, wherein the command is transmitted within a SET_PARAMETER message that is transmitted to the sending device.

30. The apparatus of claim 17, wherein the command is transmitted within a GET_PARAMETERS message that is transmitted to the sending device.

31. The apparatus of claim 17, wherein the push-type data delivery protocol is a File Delivery Over Unidirectional Transport (FLUTE) protocol.

32. A method, comprising:
receiving a command from a receiving device, the command indicating how content should be transmitted using a unicast session in accordance with a push-type data delivery protocol; and
in response to the command, transmitting information to the receiving device, the information relating to the unicast session and being in accordance with the indication provided by the received command.

33. The method of claim 32, wherein the information comprises a current file list transmitted to the receiving device.

34. The method of claim 33, wherein, in response to the command, the information comprises a list of file Uniform Resource Identifiers (URIs) transmitted to the receiving device.

35. The method of claim 33, wherein, in response to the command, the information comprises a file delivery table (FDT) instance transmitted to the receiving device.

36. The method of claim 35, wherein the FDT instance is transmitted within the unicast session.

37. The method of claim 32, wherein the information comprises at least one specific file transmitted to the receiving device.

38. The method of claim 32, wherein the command indicates that at least one specific file should not be transmitted to the receiving device.

39. The method of claim 32, wherein the command indicates that data transmission to the receiving device should be temporarily stopped without tearing down the unicast session.

40. The method of claim 32, wherein the command indicates that data transmission to the receiving device should be resumed.

41. The method of claim 32, wherein the command further indicates at least one of a range of transport objects, source blocks and encoding symbols.

42. The method of claim 32, wherein the method is implemented in accordance with a real-time streaming protocol (RTSP).

43. The method of claim 32, further comprising, before receiving the command:
receiving a query from the receiving device regarding whether the command is supported; and
in response to the query, transmitting an answer to the receiving device indicating whether the command is supported.

44. The method of claim 32, wherein the command is transmitted within a SET_PARAMETER message that is received from the receiving device.

45. The method of claim 32, wherein the command is transmitted within a GET_PARAMETERS message that is received from the receiving device.

46. The method of claim 32, wherein the push-type data delivery protocol is a File Delivery Over Unidirectional Transport (FLUTE) protocol.

47. A computer program product, embodied in a computer readable medium, comprising:
computer code for receiving a command from a receiving device, the command indicating how content should be transmitted using a unicast session in accordance with a push-type data delivery protocol; and
computer code for, in response to the command, transmitting information to the receiving device, the information relating to the unicast session and being in accordance with the indication provided by the received command.

48. An apparatus, comprising:
a processor; and
a memory unit communicatively connected to the processor and including:
computer code for receiving a command from a receiving device, the command indicating how content should be transmitted using a unicast session in accordance with a push-type data delivery protocol; and
computer code for, in response to the command, transmitting information to the receiving device, the information relating to the unicast session and being in accordance with the indication provided by the received command.

49. The apparatus of claim 48, wherein the information comprises a current file list transmitted to the receiving device.

50. The apparatus of claim 49, wherein, in response to the command, the information comprises a list of file Uniform Resource Identifiers (URIs) transmitted to the receiving device.

51. The apparatus of claim 49, wherein, in response to the command, the information comprises a file delivery table (FDT) instance transmitted to the receiving device.

52. The apparatus of claim 51, wherein the FDT instance is transmitted within the unicast session.

53. The apparatus of claim 48, wherein the information comprises at least one specific file transmitted to the receiving device.

54. The apparatus of claim 48, wherein the command indicates that at least one specific file should not be transmitted to the receiving device.

55. The apparatus of claim 48, wherein the command indicates that data transmission to the receiving device should be temporarily stopped without tearing down the unicast session.

56. The apparatus of claim 48, wherein the command indicates that data transmission to the receiving device should be resumed.

57. The apparatus of claim 48, wherein the command further indicates at least one of a range of transport objects, source blocks and encoding symbols.

58. The apparatus of claim 48, wherein the method is implemented in accordance with a real-time streaming protocol (RTSP).

59. The apparatus of claim 48, wherein the memory unit further comprises computer code for, before receiving the command:
receiving a query from the receiving device regarding whether the command is supported; and
in response to the query, transmitting an answer to the receiving device indicating whether the command is supported.

60. The apparatus of claim 48, wherein the command is transmitted within a SET_PARAMETER message that is received from the receiving device.

61. The apparatus of claim 48, wherein the command is transmitted within a GET_PARAMETERS message that is received from the receiving device.

62. The apparatus of claim 48, wherein the push-type data delivery protocol is a File Delivery Over Unidirectional Transport (FLUTE) protocol.

63. A system, comprising:
a receiving device configured to transmit a command indicating how content should be transmitted using a unicast session in accordance with a push-type data delivery protocol; and
a sending device configured to receive the command and, in response to the command, transmit information to the receiving device, the information relating to the unicast session and being in accordance with the indication provided by the command.
